(19) United States
(12) Patent Application Publication
(10) Pub. No.: US 2017/0312730 A1
(43) Pub. Date: Nov. 2, 2017

(54) METHOD FOR THERMAL PRECONDITIONING OF NATURAL GRAPHITE FLAKES USING ELECTROMAGNETIC WAVES

(71) Applicant: Syrah Resources, Melbourne (AU)

(72) Inventors: Jens Berkan, Hawthorn East (AU); Joseph Williams, Brighton (AU); Peter Barnes, Cottesloe (AU); Tah Nean Chan, Bullcreek (AU)

(73) Assignee: Syrah Resources, Melbourne (AU)

(21) Appl. No.: 15/497,583

(22) Filed: Apr. 26, 2017

Related U.S. Application Data
(60) Provisional application No. 62/329,127, filed on Apr. 28, 2016.
(60) Provisional application No. 62/341,830, filed on May 26, 2016.

(51) Int. Cl. B01J 19/20; B01J 8/18; B01J 19/12; B01J 41/00

(52) U.S. Cl. CPC B01J 19/20; B01J 8/1836; B01J 8/1881; B01J 8/1818; B01J 19/126; B01J 41/00; B01J 2219/0886; B01J 2219/1206

(57) ABSTRACT

An apparatus for processing graphite particles is disclosed. The apparatus may comprise an electromagnetic radiation emitting device including a microwave device coupled to the reaction chamber for the creation of electromagnetic waves, the electromagnetic waves comprising microwaves. The apparatus may also comprise an inlet attached to the reaction chamber for introducing graphite particles, and an outlet attached to the reaction chamber for allowing processed graphite particles to exit the reaction chamber. The graphite particles in the reaction chamber thermally altered by exposure to the electromagnetic radiation such that the graphite particles are heated

### CROSS-REFERENCES TO RELATED APPLICATIONS

This application is a non-provisional of and claims the benefit of U.S. Provisional Application No. 62/329,127, filed on Apr. 28, 2016, and U.S. Provisional Application No. 62/341,830, filed on May 26, 2016, which are herein incorporated by reference in their entirety for all purposes.

### SUMMARY

Imperfect conditions often exist during the mining and beneficiation of natural graphite. As a result, organic and mineral contaminations are always included in graphite concentrate. For example, FIG. 1 shows a microscopic image of a natural graphite flake with attached or surface-embedded mineral impurities. Different natural graphite flakes can occur in various shapes and sizes, and can have different mineral compositions and contaminant amounts. The contaminants (also referred to as or gangue minerals) can vary based on the geographic location of the mine site and the specific style of graphite deposit.

Contaminated graphite can be problematic for many applications where a high grade of graphite purity is desired. For example, high purity grade graphite is typically used for manufacturing Li-Ion battery anode material.

Current processes for purifying graphite include chemical purification and thermal graphitization. For thermal graphitization, graphite may be heated to about 3,000 degree Celsius such that included or attached impurities evaporate away from the graphite. The graphite can be heated with an external heat source that applies conductive or radiative heat transfer, or the graphite can be heated by applying a high electric current.

These heating methods can use a large amount of energy, can be subject to heat dispersion and loss, and can be slow. For example, when applying heat from an external heat source to the surface of a solid graphite sample, it can take a long time for the heat to spread throughout the interior of the graphite. In the meantime, the surface of the graphite can lose a significant amount of heat to the external environment (e.g., through conduction, convection, and radiation). Thus, the long heating time contributes to greater energy loss, resulting in the need for greater total input energy. Once sufficiently heated, more time is needed for impurities to loosen, evaporate and move through the interior of the graphite until they can reach the surface before removal from the graphite. As a result, even more time and energy is needed to keep the graphite heated (e.g., to compensate for heat loss) to ensure the impurities move outward.

Embodiments of the present invention address these problems and other problems, individually and collectively.

### SUMMARY

Embodiments of the invention are directed to improve methods, apparatuses, and systems for purifying graphite particles.

One embodiment of the invention is directed to an apparatus for processing graphite particles. The apparatus comprises a reaction chamber. An electromagnetic radiation emitting device such as a microwave device can be coupled to the reaction chamber, and can be used to create microwaves that can be introduced into the reaction chamber. An inlet is coupled to the reaction chamber and is used for introducing graphite particles into the reaction chamber. An outlet is coupled to the reaction chamber and can be used for allowing processed graphite particles to exit the reaction chamber. The graphite particles in the reaction chamber are thermally altered by exposure to the microwaves such that the graphite particles are heated, and heat is sufficiently retained.

Another embodiment of the invention is directed to a method. The method comprises introducing graphite particles into a reaction chamber via an inlet coupled to the reaction chamber, providing microwaves into the reaction chamber and to the graphite particles such that the graphite particles are heated to form processed graphite particles, and passing the processed graphite particles out of the reaction chamber via an outlet coupled to the reaction chamber.

Another embodiment of the invention is directed to an apparatus for conducting a microwave-thermal process for the direct and intrinsic heating of graphite particles by excitation of the chemical carbon bonds via electromagnetic excitation. The apparatus includes a reaction chamber and a dispersion device coupled to the reaction chamber to disperse graphite particles. The apparatus also includes a process gas dispersion device coupled to the reaction chamber to disperse process gas. The apparatus further includes a microwave device coupled to the reaction chamber for the creation of electromagnetic microwaves. Within the apparatus, the graphite particles are dispersed into the process gas and thermally altered by exposure to the electromagnetic microwaves such that the graphite particles are heated.

Another embodiment of the invention is directed to an apparatus for processing graphite particles. The apparatus comprises a reaction chamber. An inlet for receiving graphite particles can be coupled to the reaction chamber. An outlet for outputting processed graphite particles can also be coupled to the reaction chamber. A conveyor device configured to convey the graphite particles from the inlet to the outlet can be in the reaction chamber. In some embodiments, an electromagnetic radiation emitting device and/or a sound emitting device can be coupled to the reaction chamber.

Another embodiment of the invention is directed to a method. The method comprises introducing graphite particles along with a caustic material into a reaction chamber, transporting the graphite particles and the caustic material towards an outlet in the reaction chamber using a conveyor device, applying electromagnetic radiation to the graphite material and the caustic material while the graphite material and the caustic material are in the reaction chamber, and passing processed graphite material out of the reaction chamber via the outlet.

Further details regarding embodiments of the invention can be found in the Detailed Description and the Figures.

### BRIEF DESCRIPTION OF THE DRAWINGS

FIG. 1 shows an example of a natural graphite flake that is embedded with mineral impurities.

FIG. 2 shows a flowchart of an apparatus for thermal graphite purification, according to an embodiment of the invention.

FIG. 3 shows a diagram of a method for thermal graphite purification, according to an embodiment of the invention.

FIG. 4 shows a diagram of an apparatus comprising a thermo-chemical microwave powered graphite thermal purification reaction chamber.

FIG. 5 shows a diagram of a system including a multistage, microwave powered thermo-chemical reactor apparatus for the caustic chemical-thermal purification of graphite particles with an added stage and an externally thermal controlled reaction chamber.

FIG. 6 shows a flowchart illustrating another method for thermal graphite purification according to another embodiment of the invention.

### DETAILED DESCRIPTION

Prior to discussing specific embodiments of the invention, some terms may be described in detail.

A “graphite particle” may be a unit of graphite. A graphite particle may take any suitable form. For example, a graphite particle may be in the form of a flake, a sphere, an amorphous material, a modified shape form, a lump like shape, recarburised and refractory graphite, or any other suitable type or form of graphite. In some embodiments, a graphite particle can be a small piece of graphite. For example, a graphite particle may be a flake of graphite may have a flake size between about 44 μm and about 150 μm. A graphite particle may have a nominal true volume V_{T} that is greater than or equal to about V_{T}=40 μm³ and smaller than or equal to about V_{T}=500,000 μm³. A graphite particle may have a nominal particle mass M_{P} of greater than or equal to about Mp=0.003 μg and less than or equal to about M_{P}=20 μg. In some embodiments, a graphite particle may include a crystallinity parameter (defined by a nominal aromatic carbon layer stacking spacing), D₀₀₂, of greater than or equal to about 0.3354 nm and less than or equal to about 0.36 nm. Additionally, a graphite particle may have a degree of crystal lattice disorder defined by Raman Spectroscopy peak intensity ratios, I₍₁₃₅₅₎I₍₁₅₈₂₎, of less than about 1 at the surface and less than about 0.3 at the core. The graphite particles according to embodiments of the invention may be derived from natural graphite particles. Processed graphite particles that have been purified according to embodiments of the invention can have a purity greater than or equal to about 99.95% C.

The graphite particles, whether in unprocessed, preprocessed, or processed form may have average particle sizes of about 10-200 μm, preferably about 10-50 and more preferably about 10-30 μm. In some embodiments, the graphite particles may be formed from raw flake graphite that has been pulverized by a miss such as an air classifier mill or a pin mill. In some embodiments, the degree of spheroidisation or elipticity may be greater than about 0.8.

A “reaction chamber” may include an enclosure in which the processing of a substance may occur. Reaction chambers may be of any suitable shape or orientation. Suitable reaction chambers may be generally cylindrical, cone-shaped, etc. In some embodiments, the diameter or cross-section of the reaction chamber may vary along its length. Portions of the reaction chambers may also be insulated and chemically resistant in some embodiments. Other portions of the reaction chamber may have some form of external heating if desired.

An “electromagnetic radiation emitting device” may include any suitable device that can emit electromagnetic radiation, including but not limited to microwaves, infrared radiation, X-rays, gamma rays, etc. Examples of electromagnetic radiation emitting devices may include microwave devices and heaters such as infrared lamps, heating coils, resistive heating devices, etc.

A “microwave device” can be an instrument for creating microwaves. Examples of microwave devices include magnetrons (e.g., cavity magnetrons), klystrons, traveling-wave tubes, and any other suitable microwave device.

A “sound wave emitter” can be an instrument for creating sound waves. Sound waves from a sound wave emitter may cause particles to vibrate or oscillate. Examples of a sound wave emitter include a speaker (e.g., a loudspeaker), a megaphone, a drum, and any other suitable sound wave emitter. A sound wave emitter may emit sound waves (e.g., pressure waves) in a focused direction or in all directions (unidirectional or omnidirectional). Sound wave emitters may be able to emit sounds waves of one or more frequencies, and in some embodiments, sound wave emitters can be tunable. For example, a tunable sound wave emitter can create standing waves and standing wave nodes with certain settings.

A “caustic reagent” may be any suitable material that is capable of burning, corroding, dissolving, and/or eating away at another material, such as by chemical action. Caustic reagents may include acids (e.g., hydrochloric acid, sulfuric acid, nitric acid, etc.) and bases (e.g., sodium hydroxide). Caustic reagents can be in liquid, gaseous, or solid form. Other examples of caustic reagents may include lime (milk of lime) or sodium carbonate (powdered). More reactive caustic reagents may include ammonia (powder) or ammonia hydroxide (liquid), or sodium hydroxide (powder or liquid).

A “conveyor device” may any suitable device that is capable of transporting material from one location to another. Some conveyor devices may include a screw-type mechanism, which may include a rotating axle with blades periodically spaced on the axle. Rotating the axle also rotates the blades, and pushes material such as particles from an inlet of a reaction chamber to an outlet of the reaction chamber in a direction parallel to the axle.

### I. Methods and Systems Utilizing Microwaves

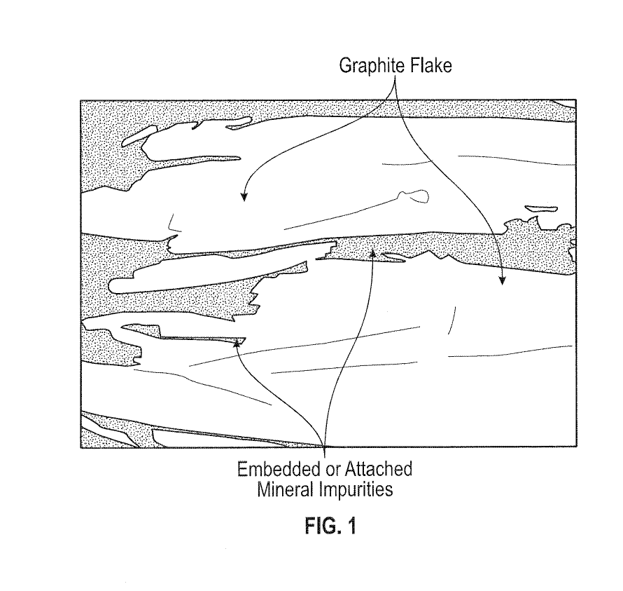

Embodiments of the invention provide an apparatus and process for removing graphite impurities such as the impurities shown in FIG. 1. A thermal treatment process using electromagnetic radiation such as microwaves can alter the physical and chemical bonds between graphite and embedded or attached impurities, thereby changing the quality and quantity of the impurities.

Some embodiments of the invention utilize electromagnetic radiation such as microwaves with a frequency that matches or is near to the wave resonant frequency of chemical carbon bonds (e.g., approximately 2.3976 GHz). When the microwaves are applied to contaminated graphite, the graphite's carbon bonds can absorb the electromagnetic microwaves such that the carbon bonds' energy levels are excited. As a result of the excitation, the local temperature can increase by an amount approximately equivalent to the amount of energy absorbed in relation to the thermal inertia of the material (provided there are no external thermal losses). With sufficient electromagnetic radiation, the graphite material can increase to a temperature that causes impurity reduction. In some embodiments, the temperature of the graphite particles may exceed about 1000° C., preferably from about 1800° C. to about 3300° C., and more preferably from about 2800 to about 3000° C.

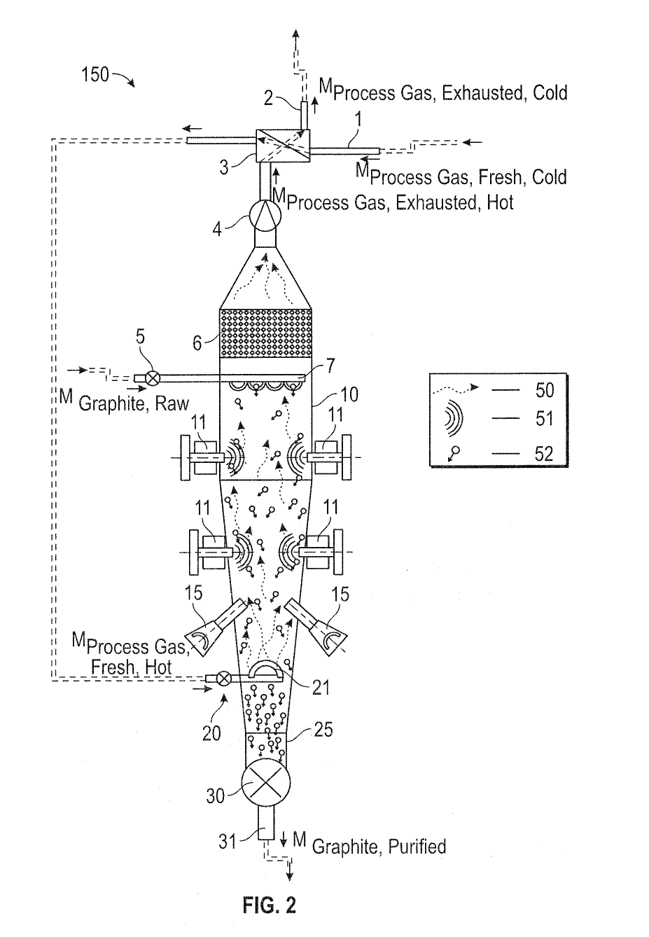

FIG. 2 shows an exemplary apparatus 150 for graphite particle purification. The apparatus comprises a vertically oriented reaction chamber 10. The reaction chamber 10 can have an aspect ratio greater than about 2:1 and is oriented vertically with respect to a long axis of the reaction chamber 10. As noted above, the reaction chamber 10 could have other configurations.

The reaction chamber 10 includes an upper portion and a lower portion. The upper portion of the reaction chamber 10 includes a process gas inlet 1 which can introduce a process gas (M_{Process gas, fresh, cold}) into the reaction chamber 10. The process gas inlet 1 may pass through a heat exchanger 3, which can heat the process gas. A process gas introduction system may be upstream of the process gas inlet 1, and may provide a fluidized bed of process gas. The heated process gas can then enter the reaction chamber 10 at the lower portion of the reaction chamber 10 via the process gas inlet 1. The inlet may take the form of a conduit for the process gas. A process gas exhaust 2 is also at the top portion of the reaction chamber 10 and may pass a cooled process gas (M_{Process gas, exhausted, cold}) away from the reaction chamber 10. A blower 4 and a filter 6 may also be at a top portion of the reaction chamber 10. Lastly, a graphite particle feeder system 5 and a graphite particle injector 7 may also be at the top portion of the reaction chamber 10, below the filter 6. Graphite particles to be processed (M_{Graphite, raw}) may be fed into the reaction chamber 10 via the particle feeder system 5 and the graphite particle injector 7.

The lower portion of the reaction chamber 10 can include a number of disperser nozzles 21 for dispersing process gas into the reaction chamber 10. The lower portion of the reaction chamber 10 may also include a valve extractor 30, as well as a collector and chiller 25, and a purified graphite particle outlet 31. Purified graphite particles (M_{Graphite, purified}) may exit the reaction chamber 10 via the outlet 31.

Graphite particles 52 inside of the reaction chamber 10 can be exposed to electrometric radiation (e.g., microwaves 51) from one or more microwave devices 11 coupled to walls of the reaction chamber 10. The walls of the reaction chamber 10 may include insulating, heat-resistant material that simultaneously reflects microwaves. For example, metals such as molybdenum or tungsten can be used in the walls of the reaction chamber 10.

The microwave devices 11 may emit fixed or variable frequency electromagnetic radiation. In some embodiments, the electromagnetic wave frequency of the microwave devices 11 can be optimized for the carbon bonds in graphite, or can be chosen according to the typically available frequency spectrum of 2.45 GHz. As an example, variable frequency magnetic radiation may sweep around the resonance frequency of the carbon bond. In some embodiments, a superposition of different microwave devices 11 with different frequencies can be used. Electrometric radiation from the microwave devices 11 may also be transferred into the reaction chamber 10 by one or more waveguides.

A graphite particle feeder system 5, which may include an inlet in the form of a tube, a valve, and a pump, can provide graphite particles 52 to a graphite particle injector 7. A graphite particle source (not shown) such as a container with the graphite particles 52 may be upstream of the graphite particle feeder system 5. The graphite particle injector 7 can inject and disperse graphite particles 52 into the upper regions of the reaction chamber 10. The graphite particle injector 7 can include dispersion aids such as Venturi nozzles or mechanical dispersers. Once injected, the dispersed graphite particles 52 may move downward toward the lower portion of the reaction chamber 10 under the influence of gravity.

Graphite particles 52 in the reaction chamber 10 can increase in temperature when exposed to electrometric radiation from the microwave devices 11. However, as the temperature of graphite particles 52 increases, the graphite particles 52 may irradiate away their energy at a higher rate. To reduce this energy loss so that the temperature can continue to increase, the graphite particles 52 can be dispersed within an agitated, homogenous (or quasi-homogenous) gas cloud within the reaction chamber 10.

An agitated gas cloud can reduce energy loss and promote energy absorption. For example, an agitated gas cloud can enable rapid energy transfer between graphite particles 52 throughout the reaction chamber 10, and thereby establish a uniform temperature across the reaction chamber 10. As a result, graphite particles 52 can all have the same temperature, such that when they irradiate, they can interfere with one another (e.g., energy irradiated away from one graphite particle can be replaced by incoming radiation of equal energy from another graphite particle). This interference can effectively cancel out the energy loss due to irradiation, and thus reduces and minimizes thermal losses to the graphite particles 52.

Additionally, an agitated quasi-homogeneous gas cloud can interact with (and thereby disperse) the graphite particles 52 throughout the reaction chamber 10. As a result, electromagnetic waves may penetrate deep into the graphite material. For example, electromagnetic waves may not be able to penetrate deeply into solid-state graphite, and the amount of penetrating radiation decreases rapidly with depth in solid-state graphite. In contrast, a gaseous cloud of distributed graphite particles 52 with a sufficiently low density can allow electromagnetic waves to penetrate throughout the entire graphite material, such that energy can be delivered to all of the graphite particles 52.

In some embodiments, a gas cloud can be created by inserting an inert or semi-inert carrier gas (such as argon, nitrogen, or air) into the reaction chamber 10. As shown in FIG. 2, gas disperser nozzles 21 (e.g., bed fluidizer nozzles) can insert and disperse gas into the lower area of the reaction chamber 10.

The reaction chamber 10 can be operated under atmospheric pressure, pressurized, or at partial vacuum. For example, a blower 4, a fan, or any other suitable mechanism can be used for creating gas movement or a pressure differential across the reaction chamber 10. In some embodiments, the process gas may flow upward (as shown by the arrows labeled as 50 in FIG. 2) toward the top of the reaction chamber (e.g., due to a fan, vacuum, or relative density). The upward flow of the gas may oppose the downward movement of graphite particles 52 (e.g., downward flow due to gravity or higher density). Interactions (e.g., collisions) between the upward-flowing gas and downward-moving graphite particles 52 may result in agitation and dispersion of the graphite particles 52. Thus, principles of a flow bed or fluidized reactor (or counter-flow reactor) can be used to achieve agitation of the graphite particles 52 in the reaction chamber 10.

A graphite particle's downward speed in the reaction chamber 10 can depend on several factors, such as the viscosity of the gas, the upward gas flow speed, and the size and shape of the graphite particle. In some embodiments, an appropriate combination of gas viscosity and gas flow speed may cause a graphite particle to reach a “terminal velocity” where it stops moving downward and remains in the same vertical area. This situation may be temporary, and the graphite particle may continue moving downward when local conditions change.

In some embodiments, the gas flow speed and/or gas viscosity may vary along the vertical axis of the reaction chamber 10. For example, the reaction chamber 10 can have a conical shape so that the gas flow speed varies along the vertical axis. Also, the counter-flow gas moving upward along the vertical axis of the reaction chamber 10 may be subject to temperature changes, which can impact the viscosity of this gaseous fluid. Such vertically-varying viscosity and gas flow speed can cause different graphite particle sizes and shapes to meet their terminal velocity in different vertical zones along the reaction chamber 10. As a result, there may be different vertically-aligned regions where different groups of graphite particles 52 are suspended in a quasi-stabilized zone until gas flow conditions change locally.

The pressure and gas flow speed inside the reaction chamber 10 can be adjusted between vacuum and overpressure, in order to optimize graphite particle cloud dispersion and chamber retention time, based on the energy and power balance between microwave irradiation and temperature-related thermal losses of the graphite particles 52.

As mentioned above, conductive, convective and radiative energy losses can increase as the graphite temperature increases. Eventually, the graphite material may reach a thermal equilibrium. As the graphite temperature rises, so may the temperature of the intrinsic and attached impurities. Accordingly, if sufficient electromagnetic wave energy is irradiated and transferred onto the graphite material, the thermal equilibrium temperature can increase to a temperature sufficient for graphite purification.

With a sufficiently high temperature, impurities can melt, boil, and/or sublimate. Melted impurities may be partly drawn to the outer surface of the graphite particle, where they may contract and concentrate into droplets due to the surface tension and interaction with the graphite surface. These droplets may partly or completely separate from the graphite as a result of evaporation or mechanical impact.

In some embodiments, sound wave emitters 15 that are coupled to the reaction chamber 10, can be used to create mechanical impact within the reaction chamber 10, such that melted impurities can be displaced (e.g., “knocked away”) from the surfaces of graphite particles 52. For example, sound waves of varying frequency and amplitude can propagate within the reaction chamber 10. The sounds waves can cause the gas molecules and/or graphite particles 52 to oscillate (e.g., accelerate and decelerate), such that in local zones there may be intense interference (e.g., collisions) between the gas and graphite particles 52. These oscillations and interferences can cause impulse transfers that aid in the removal of impurities from the graphite particle surfaces (in addition to aiding in mixing, homogenization, and agitation of the gas cloud and graphite particles 52). In other words, the sound waves can cause collisions which shake loose the impurities. In some embodiments, the gas cloud (e.g., from the dispenser nozzles 21) provides the medium through which the sound waves can travel.

The sound wave emitters 15 may provide sound waves of any suitable magnitude. For example, in some embodiments, the sound waves may provide sound intensities between about 0 dB and about 170 dB.

In some embodiments, loose impurities (e.g., impurities that have been removed from graphite particles 52) can be carried away as aerosols in the gas counter flow. For example, the upward flowing gas can carry the impurities away from the graphite particles 52 and out of the reaction chamber 10. A filter 6 at an upper end of and within in the reaction chamber 10 may block graphite particles 52 and/or allow the process gas loaded with aerosol impurities to pass through. The process gas can then be discharged via the process gas exhaust 2, and the reaction chamber 10 can be provided with fresh process gas (from the gas intake 1) via the process gas intake valve 20 and gas disperser nozzles 21.

The hot and purified graphite particles 52 can fall to the purified graphite particle collector and chiller 25 at the bottom of the reaction chamber 10. After being chilled, the purified graphite particles 52 (M_{Graphite, purified}) can be removed from the chamber through the valve extractor 30 and purified graphite particle outlet 31.

As mentioned above, during the heating process, several steps can be taken to minimize graphite particle heat loss to the walls of the reaction chamber 10. For example, thermal insulation can be included in the reaction chamber 10 walls. Also, dispersion of the graphite particle cloud (via the gas cloud) can be optimized, such that microwave absorption is optimized and homogenized throughout the graphite particle cloud cross section (e.g., due to adequate penetration). Additionally, heated graphite particles 52 that are distributed can irradiate onto one another rather than the reaction chamber 10 walls. Further, the process gas can be pre-heated before it enters the reaction chamber 10, thereby reducing convective heat losses from the graphite particles 52 to the gas cloud. In some embodiments, the process gas can be pre-heated by recuperative energy recovery through the heat exchanger 3 from the exhausted process gas.

Different impurities may have different melting, boiling, and/or sublimation temperatures. As a result, higher temperatures can remove more impurities from the graphite. In some embodiments, 650° C. may be a minimum temperature used for removing impurities. Above 1,000° C., the purification effect may increase significantly. Temperatures beyond 1,600° C. may be able to remove a substantial portion of entrapped SiO₂ mineralization. The reduction of silicon-containing contamination compounds can be particularly beneficial for graphite material intended for use in the production of battery-grade anode material. Battery-grade anode material may call for the highest levels of purity that is typically achieved through expensive hydrofluoric acid treatment.

In some embodiments, one or more functions described herein can be controlled and organized by a computer. For example, microwave emission, sound wave emission, particle dispensing, gas heating, and any other suitable functions can be computer-controlled.

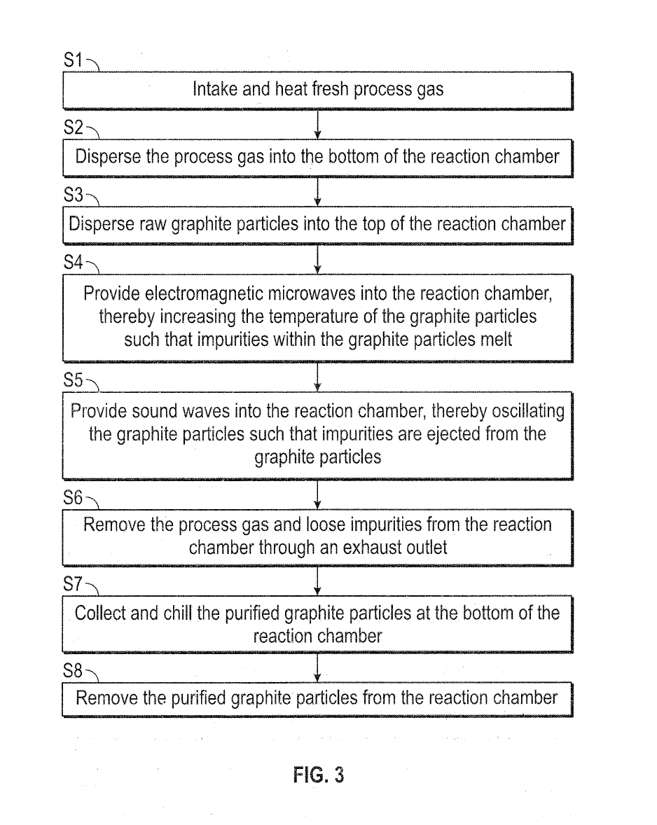

A method according to embodiments of the invention can be described with respect to FIG. 3. Note that the steps provided in FIG. 3 may or may not occur in sequence, and embodiments of the invention are not limited by the particular order of steps shown in FIG. 3. For example, although steps S4 and S5 describe the use of microwaves and sound waves to process graphite particles, respectively, it is understood that these steps may occur at the same time in some embodiments of the invention.

At step S1, fresh intake process gas may be pre-heated. At step S2, the process gas may be dispersed into the reaction chamber (e.g., at the bottom of the chamber). The process gas may flow upward in the reaction chamber (e.g., due to a vacuum, fan, low-density, etc.). In some embodiments, process gas may be continually input at the bottom of the reaction chamber and extracted at the top of the reaction chamber.

At step S3, raw graphite particles may be dispersed into the reaction chamber (e.g., near the top of the reaction chamber). The graphite particles may move downward in the reaction chamber (e.g., due to gravity). The graphite particles may flow opposite the process gas and thereby collide with the process gas. As a result, the graphite particles may be agitated and dispersed throughout the reaction chamber.

At step S4, microwaves (or other suitable electromagnetic radiation) may be radiated throughout the reaction chamber and thereby provided to the graphite particles. The graphite particles may absorb the microwave energy and increase in temperature. In some embodiments, the microwaves may penetrate throughout the dispersed graphite particles such that the graphite particles uniformly increase in temperature.

The graphite particles may irradiate away some of their gained energy. However, graphite particles may irradiate onto other neighboring graphite particles, such that the energy stays within the graphite matter and net energy loss is minimized.

Once the graphite particles reach a certain temperature, one or more types of impurities may begin to melt, boil, or sublimate. In some embodiments, impurities may melt and gather as droplets on the surface of graphite particles.

At step S5, sound waves may be emitted so that they propagate throughout the reaction chamber (e.g., through the medium of the process gas). The sound waves may provide mechanical energy to the graphite particles so that they oscillate. As a result of these oscillation accelerations or collisions with other particles, impurities (e.g., droplets on the surface of graphite particles) may be expelled from the graphite particles.

Impurities removed from the graphite particles may take the form of aerosols and travel upward along with the process gas flow. At step S6, the process gas may be exhausted from the reaction chamber, thereby separating the impurities from the graphite particles. The purified graphite particles may move in the downward in the reaction chamber, opposite the process gas and impurities.

At step S7, the purified graphite particles may be collected at the bottom of the reaction chamber and/or chilled so that the temperature is reduced. At step S8, the purified graphite particles may be removed from the reaction chamber by passing the processed graphite particles out of the reaction chamber via the outlet coupled to the reaction chamber.

In some embodiments, the downward movement and position of the graphite particles can be controlled to control the heating time. For example, the downward movement of the graphite can be slowed by increasing the flow speed of the process gas. Also, the flow speed of the process gas can be adjusted based on the viscosity of the process gas (which can change with temperature).

In some embodiments, after sufficient heating time and removal of the impurities via the process gas, the process gas flow speed and/or microwave radiation may be reduced so that the purified graphite particles can fall to the bottom of the reaction chamber. In other embodiments, the graphite particles may continually fall throughout the heating process, and may be sufficiently purified by the time they reach the bottom of the reaction chamber.

In some embodiments, one or more of the steps described herein can be optional, and the steps can take place in any suitable order. For example, in some embodiments, sound waves may be emitted throughout the purification process (e.g., not just at step S5). For example, sound waves may also be used to promote agitation and particle dispersion at the beginning of the process. In other embodiments, sound saves need not be used at all in the graphite particle purification process.

The embodiments described above may also incorporate the use of a caustic reagent in the purification of graphite particles. Further details regarding the use of caustic reagents in the graphite particle purification process are described below.

Embodiments of the invention have a number of advantages. For example, in embodiments of the invention, graphite can be purified in a time-efficient and energy-efficient manner. Efficiency is improved in many ways by utilizing a gas-filled reaction chamber that enables graphite particles to be suspended and dispersed. For example, a gas cloud facilitates fast heat transfer, such that all of the graphite particles can have a similar temperature. Thus, all of the graphite particles can reach a critical purifying temperature at the same time, thereby minimizing purification time and efficiently harnessing input energy.

Additionally, microwaves can become a viable heating source when graphite particles are dispersed in a gas cloud, as the gas cloud can sufficiently reduce the density of the graphite sample such that microwaves can penetrate evenly throughout the graphite matter. In some embodiments, using microwaves for inputting energy can cause direct and intrinsic heating of the graphite particles, thereby minimizing the amount of thermal energy needed to increase the graphite temperature. Directly heating each graphite particle can result in fast heating of the entire graphite sample (in contrast with the time delays needed for heat to travel throughout externally-heated solid state graphite). With less heating time, there can also be less energy lost to the external environment.

A gas-filled reaction chamber can also advantageously promote the extraction of impurities. For example, impurities removed from the graphite can become aerosolized and move away from the graphite particles along with the gas flow. The gas cloud can also serve as a sound wave medium, enabling the use of sound waves for removing impurities (e.g., through impulse and particle collisions). Sound waves can thereby reduce the time needed for removing impurities (and thus also reduce energy needed for maintaining a high temperature).

### II. Methods and Systems Utilizing Caustic Reagents

Many of the large scale applications of natural graphite require relatively high carbon content. For example, graphite that is used as recarburizer in an electric arc steel furnace requires a very low amount of sulfur and other organic contaminations as well as usually not more than 5%-8% in mineral contamination. Another such example is within the clean energy space. Natural graphite is used as the dominant negative electrode material in the manufacturing of Li-Ion battery systems, where only the highest grades—purities—are used. Such grades can typically only be achieved by either chemical purification or thermal graphitization.

As explained above, known processes for thermal graphitization require an external heat source, which heats the graphite by heat transfer. These methods seek to heat the graphite to approximately 3,000 degree Celsius, whereby embedded or attached impurities evaporate. Alternatively, as graphite is electrically conductive, the graphite can be used as resistive conductor directly, in an electric furnace, where the application of a high electric current through the graphite directly heats material to high temperatures for purification.

It is also known that a combination of chemical and thermal purification processes is used, in form of caustic baking. The graphite particles are mixed with a caustic substance in a certain mass ratio, depending on the quality and quantity of graphite impurities, and then heated up to several hundred degrees Celsius, in order to facilitate chemical purification by means of a chemical reaction between the caustic substance and the impurities. This chemical reaction alters the chemical properties of the remaining impurities, which can be subsequently removed from the graphite by using aqueous rinsing or acidic leaching (e.g., with HCl).

Known processes are based on fixed bed reactions with external mixing before transferring the ready mixture of graphite particles and caustic material to the reaction chamber. Also, known processes use external heating for the reaction chamber. Known processes and methods have a number of inefficiencies and disadvantages.

Traditional purification processes rely on external mixing of the graphite particles with a chemically reactive agent, i.e. caustic soda, in a set and fixed ratio. The mixture is exposed, highly compacted in a fixed bed chamber, to an external heating source for a longer period of time until a sufficient chemical reaction has occurred between the agent and the graphite-contained impurities. After this baking step, the mixture can be treated in a water-based liquid as part of the actual purification step.

This conventional thermal treatment step is inefficient. They include external, thermodynamically inefficient, heating of the in-homogenous, non-agitated mixture of graphite particles and the chemically active agent (once placed into the thermal reaction chamber). They also include the resulting need for significant over-dosage of the reagent as well as the long holding time in the thermal reaction chamber to complete the reaction. Another inefficiency relates to the large amount of chemicals that are needed to neutralize the remaining residual caustic material that did not chemically react with the impurities.

Embodiments of the invention can eliminate those disadvantages. In embodiments of the invention, a new and optimized process is provided which includes chemical purification by using caustic baking, thermal purification, and mechanical agitation. Internal and external heating processes can also be used.

In a first step of the process, the impurity containing graphite material that is to be purified within this process is mixed with a chemically reactive caustic reagent. Preferably, this caustic reagent is caustic soda (NaOH). The mixing of graphite particles (to be purified) and caustic reagent can either take place in a dedicated mixing unit (e.g., “a BEPEX® turbo mixer”) before the mixture is transferred into the purification process chamber and exposed to the purification process. Alternatively, the mixing of graphite particles (to be purified) and caustic reagent can take place directly within the purification process chamber. The mixing of graphite particles (to be purified) and caustic reagent can either take place in a dry stage (as powders, or particles). Alternatively, the mixing of graphite particles (to be purified) and caustic reagent can take place with the caustic reagent being first dissolved in aqueous solution, and then it is mixed with the graphite particles into a slurry.

The physical-chemical background of the purification reactions can be described as follows. The efficient removal of gangue silicates, quartz, feldspars and micas, can be achieved by using alkaline or acidic purification methods or a combination thereof. Any of these processes usually involves batch mixes in plastic containers or rubber lined leaching silos. The most commonly used caustic substances used in leaching are the less reactive ones. They can include, for example, lime (milk of lime) or sodium carbonate (powdered). More reactive caustic substances may include ammonia (powder) or ammonia hydroxide (liquid), or sodium hydroxide (powder).

The process of oven bulk or batch roasting of an ore treated with sodium hydroxide (NaOH) or similar caustic materials has been described as an efficient way of extracting silica and alumina from the ore. Traditionally, for thermal caustic treatment, the addition of caustic material is done in a solid phase by mixing caustic dry powder with graphite particles. Typical mass ratios can be 1:10—1:5 (caustic material to graphite). However, the addition of caustic material can also be performed in a liquid state. In the liquid state, the caustic material is first dissolved or partly dissolved in water (or in any other solvent), and the graphite particles are added and mixed. The thermal treatment can evaporate the solvent and leave a fine and homogenous mixture of graphite particles and caustic material.

The application of intense heat can allow siliceous and aluminous gangue material to diffuse and react with the caustic reagent. Caustic thermal treatments of this type can typically result in a graphite material with a purity in between 98%-99% Total Graphitic Carbon (TGC). This material can then easily be further processed and purified by other processes if needed. Caustic thermal treatment processes are fast, cost-effective, and effective (i.e., can result in a significant initial reduction in impurities).

In embodiments of the invention, two different methods of mixing the graphite particles with the caustic reagent, i.e. NaOH, are described. In the first method, graphite particles are dispersed into a thick slurry of highly concentrated NaOH, dissolved in an aqueous solution, and then homogenized and thickened under mechanical agitation (stirring). The aqueous solvent is then subjected to evaporation to solidify the slurry. In the second method, the mixing and homogenizing of graphite particles occurs with NaOH powder.

For both methods, the favored mixing ratio, by mass, is between 95% and 80% graphite particles into between 5% and 20% caustic material. However, other ratios, and a variation of caustic material work as well.

In embodiments the invention, both of the above mixing methods can be used, as well as alternative caustic reagents. In embodiments of the invention, both mixing methods can take place at different stages of the purification process. It is possible to mix the graphite particle and the caustic reagent within a dedicated mixer, and then transfer the readily mixed mixture into the thermo-chemical reaction chamber. It is alternatively possible to design parts of the thermo-chemical reaction chamber such that mixing of the graphite particles and the caustic reagent can take place directly within the thermo-chemical reaction chamber. Within the thermo-chemical reaction chamber, this resulting mixture is then, in a first step, agitated and simultaneously exposed to microwave-heated process.

The effectiveness of this process is based on the interference of the graphite carbon bonds with, and absorption of, electromagnetic radiation. The corresponding wave resonance frequency of the carbon bond is described in literature as being approximately 2.3976 GHz (very close to the commercially available frequency of 2.455 GHz). The chemical carbon bonds of the graphite will absorb the irradiated electromagnetic microwaves and correspond with an excitation of the bond's energy level and thus to a local temperature increase equivalent to the absorbed energy in relation to the thermal inertia of the material, under the assumption of a thermal equilibrium and the exclusion of external thermal losses. As these graphite particles are embedded into the mixture of caustic material, and impurities are embedded into the graphite particles, the entire mixture of impure graphite and caustic reagent will eventually be evenly heated by means of heat transfer throughout the graphite.

If sufficient electro-magnetic wave energy is irradiated and transferred onto the graphite material, its temperature will eventually increase significantly, and conductive, convective and radiative energy losses by means of interference between the caustic-graphitic material and the purification equipment will increase to the point of thermal equilibrium of the matter and equipment temperature.

Some embodiments of the invention are directed to a design of a system including a first apparatus comprising a first reaction chamber, and a downstream second apparatus comprising a second reaction chamber in the form of an elongated housing, connected by a connecting device. The connecting device may be a conduit that may connect an outlet of the reaction chamber to an inlet of the second reaction chamber. The system can incorporate: (1) materials that are chemically inert to the caustic substances; (2) materials that can operate at the intended purification temperatures; (3) clearances that can compensate for thermal expansions; (4) materials that reflect microwaves; and (5) external thermal insulation.

In the processing of graphite particles, as the penetration and absorption of electromagnetic waves exponentially decreases with the intrusion depth into the absorbing material, homogenous agitation of the absorbing material occurs. Embodiments of the invention can address this problem by incorporating an agitation mechanism in the reaction chamber. In one embodiment, the agitation mechanism can be a conveying device that is similar to a screw conveyor type, which can be single screw, twin screw, in parallel or counter direction etc. Also, the agitation mechanism can be equipped with fins or blades that interfere with the main thrust or transport direction of the agitation mechanism for the transportation of the absorbing material through the chamber. This can internally and permanently re-distribute and re-orientate the material in terms of re-mixing.

When raising temperature of the graphite particle, the temperature of the intrinsic and attached impurities as well as the caustic reagent likewise increases. In the case of using an aqueous dispersion and mixing process, initially the solvent and the water will be heated and evaporated from the slurry mixture leaving behind a dry and homogenous mixture of the graphite particles and the caustic reagent.

When using caustic soda, as soon as the temperature of the mixture increases above approximately 320° C., the caustic material can start to melt and therefore the consistency of the mixture changes into a high viscose multi-phase flow type. This limits the magnitude of agitation of this mixture as the shear rates in between graphite particles are kept below a critical value, above which mechanical destruction of the graphite particles could commence or become significant.

Different impurities have different melting and boiling or sublimation temperatures, as well as different chemical activation energies for the chemical reaction between the impurity and the caustic material. With increasing temperature, impurities melt, and are partly drawn to the outer surface of the graphite particle. Caustic material melts, and is partly drawn into the micro-cavities of the particles, and chemical reactions increase. The result is an alteration of the chemical properties of the impurities. Basically, the chemical reactions between the impurities and the caustic material will result in new chemical compositions that are easily dissolvable in acidic-aqueous solutions, i.e. HCl-water.

The higher the temperature and the longer the time of exposure, the more impurities can be removed from, or chemically altered within, the graphite. The temperature of the caustic reagent and graphite particle mixture may be between about 500° C. and 800° C., and preferably between about 550° C. and about 750° C. in the reaction chamber. The time duration in the reaction chamber may also vary. A suitable holding time for graphite particles in the reaction chamber may be between about 120 s to about 2000 s, and preferably from about 300 s and about 2,000 s. This will remove a substantial portion of entrapped SiO₂ mineralization, according to the chemical reaction (or similar):

²NaOH_{(aq)}+SiO₂₍ₛₒₗ₎→Na₂SiO_{3(aq)}+H₂O_{(aq)}

In one embodiment of this invention, the purification system including the thermo-chemical reaction chamber can be divided into at least two distinctive sections. The first one is designed by the above described principles of mixing agitation and slow transportation throughout the chamber, while simultaneously heating the graphite—caustic reagent mixture by means of microwaves or other form of electromagnetic radiation. A second part is one wherein the heated graphite—caustic reagent mixture is predominantly conveyed through without mixing agitation while simultaneously being mechanically compacted and compressed while the temperature of the mixture is externally controlled by means of external heating, cooling, or insulation. This second section represents a “holding” section during which the chemical reactions within the mixture can progress or finish off, and towards which end the temperature of the finished mixture can be lowered in a controllable way.

The cold and chemically reacted product material can subsequently be treated by a simple and cost effective aqueous leaching process, involving conventional acids such as HCl, in order to remove residual contaminants resulting from the caustic reagent and its chemical reactions with the originally graphite-embedded impurities.

The reduction of silicon containing quartz contamination compounds is particularly beneficial if the purified graphite particle material is supposed to be used for the production of Li-Ion battery grade anode material. Such material requires highest levels of purity, because the alternative chemical purification method for quartz is based on an expensive hydrofluoric acid treatment. Therefore, the method of embodiments of the invention advantageously improves the purity of contaminated graphite particles and subsequently reduces the amount of any additional hydrofluoric acid that might be required for further purification by means of an acid purification treatment.

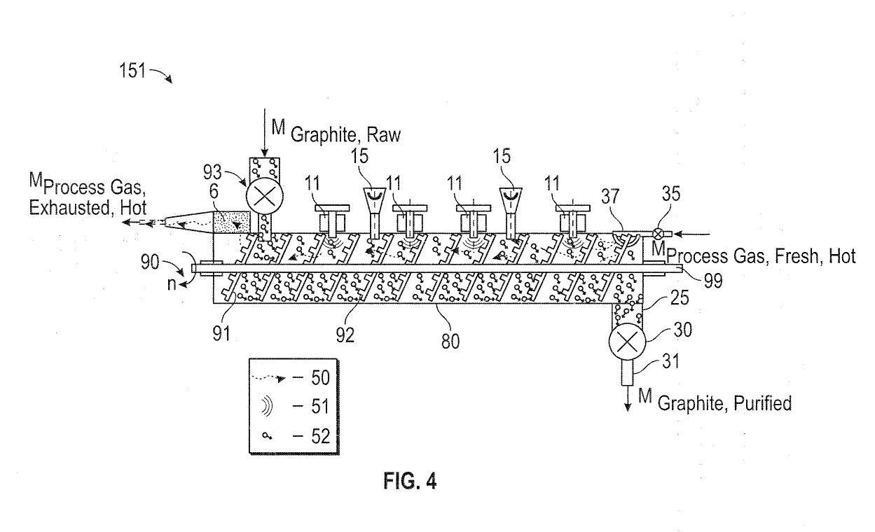

FIG. 4 shows diagram of an apparatus 151 where the exemplary process is carried out. The apparatus resembles a horizontal counter-flow thermal reaction chamber with the main source for material transportation being of mechanical nature. In this particular embodiment, a screw type conveyer unit is chosen that additionally carries fins and notches attached to the screw blade that maximizes re-mixing and agitation of the graphite-caustic-reagent-mix.

The whole apparatus can be thermally insulated or even additionally externally heated. The material is added to the thermal reaction chamber on the left and conveyed by the screw type conveyor through the thermal reaction chamber where microwave heating is as well as sound wave agitation can be applied.

A counter-flow of process gas (i.e. inert N₂ or argon) can optionally be applied from the right to the left side whereby liberated evaporating impurities are carried away. Or, in case of previous aqueous mixing of the caustic reagent and the graphite, a steam can be carried away.

The treated product mix is eventually released from the thermal process chamber on the right side from where it can be used for further treatment, i.e. aqueous leaching.

The apparatus 151 in FIG. 4 includes a reaction chamber 80 such as a thermo-chemical reaction chamber that can be elongated. The reaction chamber 80 is oriented horizontally in this embodiment. An axle 99 can pass lengthwise through the reaction chamber 80. A number of conveyor blades 91 can be coupled to the axle 99, and each conveyor blade 91 may have a number of mixing aids (e.g., fins, knobs, protrusions, recesses, etc.) 92 extending from or present in the faces of the blades 91. The blades 91 are shown as being at an angle relative to the direction of the axle 99. The axle 99 may rotate 90 so that any graphite particles 52 and any caustic material inside of the reaction chamber 80 can adequately mix together, and can move from left to right in FIG. 4.

A number of devices may be coupled to the reaction chamber 80. Such devices may include a number of microwave devices 11 (e.g., magnetrons), and sound wave emitters 15. These devices are described in detail above.

A process gas intake 35 and a process gas disperser 37 may be at one end of the reaction chamber 80 and may introduce and disperse a fresh, hot, process gas to the interior of the reaction chamber 80. A valve extractor 30 and a purified graphite particle outlet 31 can be at the bottom of the reaction chamber 80 and at the same end of the reaction chamber 80 as the process gas intake 35 and the process gas dispenser 37.

A feeder system 93 for feeding a graphite particle and caustic material mixture may be at the other end of the reaction chamber 80. A separate graphite particle source (e.g., a container containing unprocessed graphite particles) and a caustic reagent source (e.g., a container containing a caustic reagent) (not shown in FIG. 4) may be upstream of the feeder system 93. Also, a filter 6 and a process gas exhaust may be at the same end of the reaction chamber 80 as the feeder system 93.

In operation, raw natural graphite (M_{Graphite, raw}) and a caustic material are fed into the reaction chamber 80 at a first end of the reaction chamber 80 through a feeder system 93. At the same time, a process gas (M_{Process gas, fresh, hot}) is fed into the reaction chamber 80 via the process gas intake and the process gas disperser 37. Also at the same time, the axle 99 can rotate in the direction 90 and can be aligned with the axial direction of the reaction chamber 80, so that the blades 91 turn with the axle 99. As the process gas 50 travels from right to left in the reaction chamber 80, the graphite particles 52 and the caustic material travels from left to right in the reaction chamber 80, countercurrent to the process gas 50. The process gas 50 may eventually exit the reaction chamber (M_{Process gas, exhausted, hot}) a process gas outlet containing the filter 6.

As the graphite particles 52 travel within the reaction chamber 80 towards the valve extractor 30 and the purified graphite particle outlet 31, the microwave devices 11 may introduce microwaves into the reaction chamber 80 heating the graphite particles 52. Also, the sound wave emitters 15 can introduce sound waves into the reaction chamber 80. A purified stream of graphite particles (M_{Graphite, purified}) exits the purified graphite particle outlet 31.

The agitated conveyor blades 91 in conjunction with the mixing aides 92 homogenously re-distributes the graphite-particle-caustic-reagent-mixture throughout the thermo-chemical reaction chamber 80, which may include a housing. The mixture material is exposed to the microwaves irradiated from the microwave devices (e.g., magnetrons) 11 and optionally additionally agitated by sound waves emitted by the sound emitting devices 15. The material heats up and is slowly and evenly conveyed through the thermo-chemical reaction chamber from the intake side on the left to the outlet side on the right. During the agitated time of exposure, the chemical described reactions occur.

The thermo-chemical reaction chamber 80 may have a housing and its interior are built of heat resistant materials that simultaneously reflect the microwaves. Metals can be used to form the reaction chamber 80. The reaction chamber may also include one or more microwave devices 11 attached to it whereby the produced electro-magnetic microwaves are transferred via waveguides into the reaction chamber 80. The magnetrons can be built with fixed or variable frequency, sweeping around the resonance frequency of the carbon bond, or a superposition of different magnetrons with different frequencies can be used.

The reaction chamber 80 can be operated under atmospheric pressure, pressurized, or at partial vacuum. The reaction chamber 80 can be equipped with a filter 6 through which the active and impurity aerosol loaded process gas is removed from the chamber. The process gas can be conventionally pre-heated, i.e. by recuperative energy recovery through a heat exchanger from the exhausted process gas or any other heat source available.

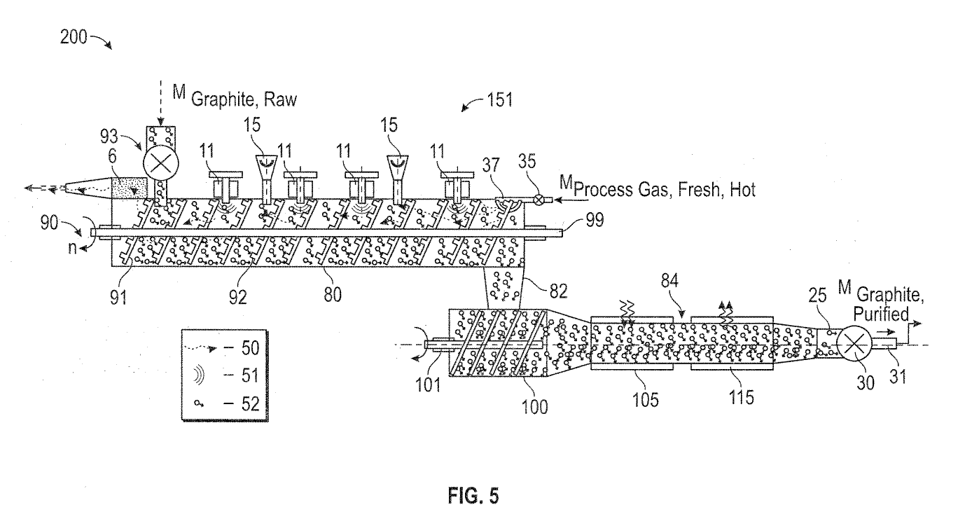

FIG. 5 shows a system 200 for purifying graphite particles according to an embodiment of the invention. In FIG. 5, the system 200 includes a first apparatus 151 including a horizontally oriented microwave heated thermo-chemical reaction chamber 80, combined with a second apparatus 84 comprising an elongated housing, which may form a second reaction chamber, via a connecting device 82. The purified graphite particles can exit an outlet in the first apparatus 151, and can pass through a connecting device 82, and into an inlet in the second apparatus 84. The second apparatus 84 includes an added compaction section 100 through which the heated mixture of graphite particles and caustic reagent is slowly pushed and compacted by means of a conveying system 101 out of the elongated housing via a purified graphite particle collector and chiller 25, a valve extractor 30, and a purified graphite particle outlet 31. The compaction section 100 performing a compaction function can be additionally thermally controlled by means of external heating 105, and thermal insulation or cooling 115. The compaction section 100 may also include sections that decrease in diameter as the purified graphite particles move downstream to compact them. The external heating 105 and the thermal insulation and cooling 115 may be for external heat transfer for temperature control of the graphite particle and caustic reagent mixture.

Embodiments of the invention can apply to all forms of graphite, flakes, amorphous material, shape-modified forms, recarb and refractory etc. However, preferably the invention applies to flake graphite of preferably about 44 μm to about 150 μm flake size.

Due to the direct intrinsic heating effects, combined with the mixing agitation, thermal energy and caustic reagent requirements are minimized. Embodiments of the invention are advantageously energy and cost efficient.

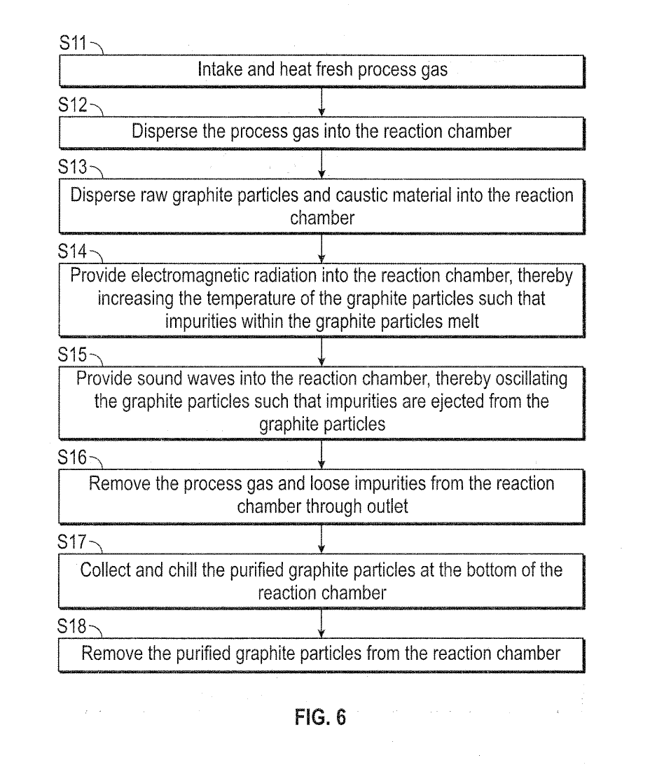

A method according to embodiments of the invention can be described with respect to FIG. 6. Note that the steps provided in FIG. 3 may or may not occur in sequence, and embodiments of the invention are not limited by the particular order of steps shown in FIG. 6. For example, although steps S14 and S15 describe the use of microwaves and sound waves to process graphite particles, respectively, it is understood that these steps may occur at the same time in some embodiments of the invention.

At step S11, fresh intake process gas may be pre-heated. At step S12, the process gas may be dispersed into the reaction chamber (e.g., at the top or bottom of the reaction chamber) via a process gas inlet. The process gas may flow horizontally in the reaction chamber toward a process gas outlet in the reaction chamber, opposite the process gas inlet.

At step S13, raw graphite particles and a caustic material may be dispersed into the reaction chamber (e.g., at the top of the reaction chamber at an end opposite the process gas inlet). The graphite particles may move horizontally along a length of the reaction chamber though the use of the conveyor device. The graphite particles may flow in a direction opposite the process gas and thereby interact with the process gas. As a result, the graphite particles may be agitated and dispersed throughout the reaction chamber.

At step S14, microwaves (or other suitable electromagnetic radiation) may be radiated throughout the reaction chamber and thereby provided to the graphite particles. The graphite particles may absorb the microwave energy and increase in temperature. In some embodiments, the microwaves may penetrate throughout the dispersed graphite particles such that the graphite particles uniformly increase in temperature.

The graphite particles may irradiate away some of their gained energy. However, graphite particles may irradiate onto other neighboring graphite particles, such that the energy stays within the graphite matter and net energy loss is minimized.

Once the graphite particles reach a certain temperature, one or more types of impurities may begin to melt, boil, or sublimate. In some embodiments, impurities may melt and gather as droplets on the surface of graphite particles.

At step S15, sound waves may be emitted so that they propagate throughout the reaction chamber (e.g., through the medium of the process gas). The sound waves may provide mechanical energy to the graphite particles so that they oscillate. As a result of these oscillation accelerations or collisions with other particles, impurities (e.g., droplets on the surface of graphite particles) may be expelled from the graphite particles.

Impurities removed from the graphite particles may take the form of aerosols and travel upward along with the process gas flow. At step S16, the process gas may be exhausted from the reaction chamber, thereby separating the impurities from the graphite particles. The purified graphite particles may move in the downward in the reaction chamber, opposite the process gas and impurities.

At step S17, the purified graphite particles may be collected at the bottom of the reaction chamber and/or chilled so that the temperature is reduced. At step S18, the purified graphite particles may be removed from the reaction chamber by passing the processed graphite particles out of the reaction chamber via the outlet in the reaction chamber.

The table below provides labels for the reference numbers in the figures.

| Item | Description |
|---|---|
| 1 | process gas inlet |
| 2 | process gas exhaust |
| 3 | heat exchanger |
| 4 | blower |
| 5 | graphite particle feeder system |
| 6 | filter |
| 7 | graphite particle injector 7 |
| 10 | reaction chamber |
| 11 | magnetron, microwave emitter |
| 15 | sound wave emitter |
| 20 | process gas air intake valve |
| 21 | dispenser nozzles |
| 25 | purified graphite particle collector |
| | and chiller |
| 30 | valve extractor |
| 31 | purified graphite particle outlet |
| 35 | process gas intake |
| 37 | process gas disperser |
| 50 | symbol for process air flow |
| 51 | symbol for microwaves |
| 52 | symbol for graphite particle flow |
| 80 | thermo-chemical reaction chamber |
| 82 | connecting device |
| 84 | second apparatus |
| 90 | agitation (rotation) of the conveyor |
| 91 | conveyor blades (screw blades) |
| 92 | mixing aids |
| 93 | feeder system |
| 99 | axle |
| 100 | added compaction section |
| 101 | conveying system |
| 105 | external heating |
| 115 | external cooling |
| 150 | apparatus |
| 151 | apparatus |
| 200 | system |
| \dot{M} Process gas, exhausted, cold | process gas flow, exhausted, cold |
| \dot{M} Process gas, fresh, cold | process gas flow, fresh, cold |
| \dot{M} Process gas, exhausted, hot | process gas flow, exhausted, hot |
| \dot{M} Graphite, raw | unpurified graphite particle mass flow |
| \dot{M} Process gas, fresh, hot | process gas flow, fresh, hot |
| \dot{M} Graphite, purified | purified graphite particle mass flow |

The embodiments of the invention that are described above can be used to product highly pure, graphite particles suitable for use in devices such as lithium ion batteries. In some embodiments, the purified graphite particles may be further subjected to a coating process, whereby the purified graphite particles are coated with a protective coating such as a hard carbon, polymer, of metal containing material. Such coatings can improve the performance of the graphite particles when they are present in an anode of a lithium ion battery.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. An apparatus for processing graphite particles, the apparatus comprising:
a reaction chamber;
an electromagnetic radiation emitting device comprising a microwave device coupled to the reaction chamber for creating electromagnetic waves, the electromagnetic waves comprising microwaves;
an inlet attached to the reaction chamber for introducing graphite particles; and
an outlet attached to the reaction chamber for allowing processed graphite particles to exit the reaction chamber,
wherein the graphite particles in the reaction chamber thermally altered by exposure to the electromagnetic radiation such that the graphite particles are heated.

2. The apparatus of claim 1, wherein the apparatus further comprises:
a dispersion device coupled to the reaction chamber to disperse the graphite particles; and
a process gas dispersion device coupled to the reaction chamber to disperse process gas.

3. The apparatus of claim 2, wherein the microwave device provides microwaves of one or more fixed frequencies.

4. The apparatus of claim 1, wherein the microwave device provides tunable microwaves or microwaves with sweeping frequencies.

5. The apparatus of claim 1, wherein the reaction chamber varies in cross section along a length of the reaction chamber.

6. The apparatus of claim 1, wherein the reaction chamber varies in cross section along a length of the reaction chamber.

7. The apparatus of claim 1, wherein the reaction chamber is thermally insulated.

8. The apparatus of claim 1, further comprising:
a process gas introduction system coupled to the reaction chamber that creates a fluidized bed of process gas.

9. The apparatus of claim 1, further comprising:
a graphite particle source containing the graphite particles.

10. The apparatus of claim 1, further comprising:
a caustic reagent source coupled to the reaction chamber, the caustic reagent source containing a chemically reactive caustic reagent.

11. The apparatus of claim 10, wherein the chemically reactive caustic reagent is a solid or a liquid.

12. The apparatus of claim 1, further comprising a conveyor device configured to convey the graphite particles from the inlet to the outlet.

13. The apparatus of claim 1, further comprising a conveyor device configured to convey the graphite particles from the inlet to the outlet, wherein the conveyor device is a screw conveyor.

14. The apparatus of claim 1, further comprising:
a sound wave emitter coupled to the reaction chamber for creating sound waves to be applied to the graphite particles

15. The apparatus of claim 14, wherein the sound wave emitter provides sound waves with fixed frequencies, or sweeping frequencies, between 20 Hz and 40 kHz.

16. The apparatus of claim 14, wherein the sound wave emitter provides sound waves with sound intensities between 0 dB and 170 dB.

17. The apparatus of claim 1, wherein the graphite particles have a nominal true volume V_{T} of not less than about V_{T}=40 μm³ and not larger than about V_{T}=500,000 μm3, or a nominal particle mass M_{P} of not less than about M_{P}=0.003 μg and not larger than about M_{P}=20 μg, and crystallinity parameter defined by a nominal aromatic carbon layer stacking spacing, D₀₀₂, of not less than about 0.3354 nm and not greater than about 0.36 nm, and degree of crystal lattice disorder defined by Raman Spectroscopy peak intensity ratios, I₍₁₃₅₅₎/I₍₁₅₈₂₎, of less than about 1 at the surface at less than about 0.3 at the core.

18. The apparatus of claim 1, wherein the reaction chamber is vertically oriented.

19. The apparatus of claim 1, wherein the reaction chamber is horizontally oriented.

20. The apparatus of claim 1, wherein the inlet is at a first end of the reaction chamber, and the outlet is at a second, opposite end of the reaction chamber.

21. A method comprising:
introducing graphite particles into a reaction chamber via an inlet coupled to the reaction chamber;
providing microwaves into the reaction chamber and to the graphite particles such that the graphite particles are heated to form processed graphite particles; and
passing the processed graphite particles out of the reaction chamber via an outlet coupled to the reaction chamber.

22. The method of claim 21, further comprising:
dispersing the graphite particles within the reaction chamber.

23. The method of claim 21, further comprising:
introducing a process gas into the reaction chamber; and
inducing the process gas to flow upward within the reaction chamber, wherein the process gas disperses the graphite particles.

24. The method of claim 23, wherein the process gas is a carrier gas.

25. The method of claim 21, further comprising:
introducing, a chemically reactive caustic reagent into the reaction chamber; and
mixing the chemically reactive caustic reagent into the reaction chamber with the graphite particles.

26. The method of claim 25, wherein the chemically reactive caustic reagent is NaOH, and wherein the graphite particles and the NaOH are mixed in a mass ratio of NaOH to graphite of about 1:30 to about 1:5.

27. The method of claim 25, further comprising:
heating the graphite and caustic reagent mixture to a temperature between 500° C. and about 800° C.

28. The method of claim 27, further comprising:
holding the graphite and caustic reagent mixture in the reaction chamber at the temperature for a time duration between about 120 s and about 2000 s.

29. The method of claim 25, wherein applying microwaves to the graphite particles such that the graphite particles are heated to form processed graphite particles occurs at one or more fixed frequencies or sweeping frequencies.

30. The method of claim 25, wherein the reaction chamber is in an apparatus that comprises:
(a) a first stage comprising the reaction chamber utilizing microwaves for generation of heat within the graphite particles;
(b) a second stage utilizing external heat transfer for temperature control of the graphite particle and caustic reagent mixture; and
(c) a compaction function in order to increase a density of the caustic reagent and graphite particle mixture.

31. The method of claim 21, wherein the reaction chamber has a cross-section that varies along a length of the reaction chamber.

32. The method of claim 21, wherein the reaction chamber has a cross-section that varies along a length of the reaction chamber.

33. The method of any of claim 21, further comprising:
introducing sound waves into the reaction chamber and applying the sound waves to the graphite particles.

34. The method of claim 33, wherein the sound waves are have fixed or sweeping frequencies between about 20 Hz and about 40 kHz, and a sound intensity between about 0 db and about 170 dB.

35. The method of any of claim 21, wherein the graphite particles produced have a nominal true volume V_{T} of not less than about V_{T}=40 μm³ and not larger than about V_{T}=500,000 μm3, or a nominal particle mass M_{P} of not less than about M_{P}=0.003 μg and not larger than about Mp=20 μg, and crystallinity parameter defined by a nominal aromatic carbon layer stacking spacing, D₀₀₂, of not less than about 0.3354 nm and not greater than about 0.36 nm, and degree of crystal lattice disorder defined by Raman Spectroscopy peak intensity ratios, I₍₁₃₅₅₎/I₍₁₅₈₂₎, of less than about 1 at a surface at less than about 0.3 at a core.

36. An apparatus for processing graphite particles comprising:
a reaction chamber;
an inlet for receiving graphite particles attached to the reaction chamber;
an outlet for outputting processed graphite particles attached to the reaction chamber;
a conveyor device configured to convey the graphite particles from the inlet to the outlet; and
an electromagnetic radiation emitting device coupled to the reaction chamber, the electromagnetic radiation emitting device for heating the graphite particles in the reaction chamber.

37. The apparatus of claim 36, wherein the conveyor device is a screw conveyor.

38. The apparatus of claim 36, wherein the inlet is a first inlet and the outlet is a first outlet, and wherein the reaction chamber further comprises a second inlet coupled to the reaction chamber for receiving a process gas and a second outlet coupled to the reaction chamber for exhausting the process gas.

39. The apparatus of claim 36, further comprising a sound emitting device coupled to the reaction chamber.

40. The apparatus of claim 36, wherein the reaction chamber is cylindrical and the conveyor device comprises an axle and blades coupled to the axle, wherein the axle is aligned with an axial direction of the reaction chamber.

41. The apparatus of claim 36, comprising:
a caustic material and the graphite particles within the reaction chamber.

42. A system comprising:
the apparatus of claim 36; and
a compaction device coupled to the outlet.

43. The system of claim 42, further comprising a connecting device, wherein the compaction device is present in an elongated housing, wherein the elongated housing is attached to the apparatus via the connecting device.

44. A method comprising:
introducing graphite particles along with a caustic material into a reaction chamber;
transporting the graphite particles and the caustic material towards an outlet in the reaction chamber using a conveyor device;
applying electromagnetic radiation to the graphite material and the caustic material while the graphite particles and the caustic material are in the reaction chamber; and
passing processed graphite particles out of the reaction chamber via the outlet.

45. The method of claim 44 further comprising:
applying sound waves to the graphite material and the caustic material while the graphite material and the caustic material are in the reaction chamber.

46. The method of claim 44 further comprising:
compacting the graphite particles after passing the processed graphite particles out the reaction chamber.

47. The method of claim 46 further comprising:
chilling the compacted graphite particles.
